(19) United States
(12) Patent Application Publication
(10) Pub. No.: US 2024/0123895 A1
(43) Pub. Date: Apr. 18, 2024

(54) AXEL WITH V-SHAPE CUT FOR RATCHETED LASHING STRAP ASSEMBLY

(71) Applicant: Gert HESSELHOLT VINGE KOUSTRP, Hornslet (DK)

(72) Inventor: Gert HESSELHOLT VINGE KOUSTRP, Hornslet (DK)

(21) Appl. No.: 18/287,051

(22) PCT Filed: Apr. 16, 2021
(86) PCT No.: PCT/EP2021/059955

§ 371 Date: Oct. 16, 2023

(51) Int. Cl. B60P 7/08

(52) U.S. Cl. CPC B60P 7/0853

(57) ABSTRACT

A ratcheted lashing strap assembly is described as a lashing strap and a tightening device. The tightening devise has a frame and a winding axel, rotatable in the frame for winding up the lashing strap.

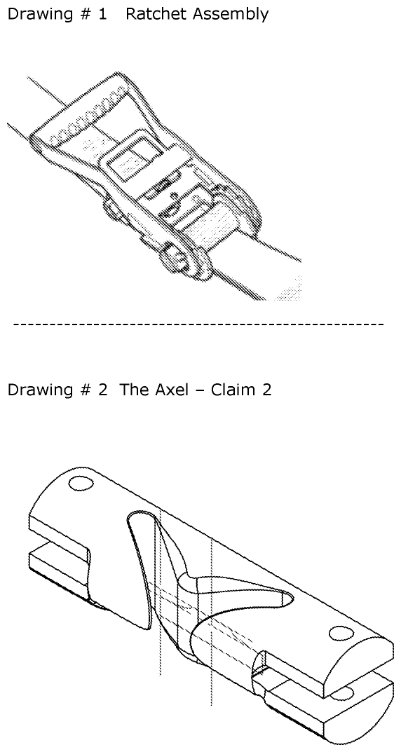

The rotatable axel is formed in steel and has a V-shaped cut in the axel that enables the initial fastening of the strap onto the axel very easy and fast. The fastening of the strap can be done anywhere on the length of the strap. With 2 turns of the axel the lashing strap is secured for its total load capacity.

The release of the lashing strap is equally easy as the strap can be removed from the V-Shaped cut in the axel without having to pull i through an opening in the axel.

A rotatable axel is formed in steel with a V-shaped cut enabling ease of initial fastening and removal of a lashing strap to a ratcheted strap assembly.

The V shaped cut makes it possible for the user to attach the strap to the ratcheted assembly without having to pull the strap through a slice in the axel. The strap can be attached anywhere in the length of the strap by placing the strap into the V-shaped cut in the axel. The strap is fastened in the V-shaped cut and with two turns of the axel the strap is secured.

Removing the strap is as well easy and takes less physical work as the strap is not to be pulled through the slit in the axel but can be removed and lifted out when the Ratchet is released.

The axel can be a part of a new ratcheted lashing strap assembly or can replace existing axels in already produced ratcheted lashing strap assemblies.

We claim:

1. A Ratchet Lashing Strap assembly comprising,
a. Lashing strap for wrapping around goods to be secured
b. A method of operating a rachet strap tightener using a power driven rotary tool, the rachet strap tightener comprising a tightener body, a spindle rotatably supported about a spindle axis relative to the tightener body for winding a first strap thereon in first direction, a first mating part rotatable with the spindle relative to the tightener body and a ratcheting mechanism arranged to selectively restrict rotation of the spindle relative to the tightener body in an opposing second direction, the power driven rotary tool comprising a tool body, a second mating part arranged to mate with the first mating part of the rachet strap tightener and arranged to be driven to rotate about a drive axis, the method comprising
i. anchoring the tool body relative to the tightener body,
ii. mating the second mating part of the rotary driven tool with the first mating part of the rachet strap tightener; and
iii. driving the second mating part of the rotary driven tool to rotate the spindle of the rachet strap tightener.
c. The axel of the Ratcheted Lashing Strap can be removed and replaced by another axel with the same diameter and the same securing features securing the axel to the frame and ratcheting mechanics.

2. The method according to claim 1 with the Axel being formed in steel and with a V shaped 120 deg. cut enabling the securing of the strap onto the axel such that.
a. The strap can be secured on the axel anywhere on the length of the strap.
b. By placing the strap into the V-shape and initiate 2 turns of the axel the strap is secured and can be tightened to the full load capacity of the strap.
c. After the release of the Rachet the strap is loose and can be removed from the V-shaped axel without having to pull the end of the strap through an opening in the axel.

3. A Ratcheted Lashing Strap assembly comprising.
a. The Method according to claim 1 and the Axel according to claim 2 as 2 separate items.
b. The Axel according to claim 2 is used as replacement for the Axel according to claim 1 (a Ratchet Lashing Strap assembly) forming a new Ratcheted Lashing Strap assembly working in accordance with claim 2.
